(19) United States
(12) Patent Application Publication
(10) Pub. No.: US 2024/0233359 A1
(43) Pub. Date: Jul. 11, 2024

(54) DEPLOYING DEEP LEARNING MODELS AT EDGE DEVICES WITHOUT RETRAINING

(71) Applicant: International Business Machines Corporation, Armonk, NY (US)

(72) Inventors: Achintya Kundu, Singapore (SG); Rhui Dih Lee, Singapore (SG); Laura Wynter, Singapore (SG); Luis Angel Bathen, San Jose, CA (US); Nirmit V. Desai, Yorktown Heights, NY (US)

(21) Appl. No.: 18/151,502

(22) Filed: Jan. 9, 2023

(51) Int. Cl. G06V 10/70; G06V 10/82

(52) U.S. Cl. CPC G06V 10/87; G06V 10/82; G06V 2201/07

(57) ABSTRACT

Computer-implemented methods for deploying models at edge devices without retraining. Aspects include receiving, from a user an identification of a computing task to be performed by an edge device and obtaining, a data set corresponding to the computing task. Aspects also include determining a supernet model space based at least in part on the computing task and creating a plurality of trained models for the computing task by training a plurality of deep learning models within the supernet model space with the data set. Aspects further include deploying one of the plurality of trained models to the edge device, wherein the one of the plurality of trained models is determined based at least in part on one or more characteristics of the edge device.

### BACKGROUND

The present invention generally relates to processing by edge devices, and more specifically, to computer systems, computer-implemented methods, and computer program products to deploy deep learning models at edge devices without retraining.

Deep learning models are used to perform various computing tasks. In general, deep learning models are machine learning models that require training to perform specified computing tasks. The training process often requires large training data sets and substantial computational resources to train the deep learning model using the training data set. Edge computing devices, such as laptops, smartphones, and internet-of-things (IoT) connected devices, typically have limited available memory and limited available processing power, which restricts the ability to train a deep learning model on an edge device.

### SUMMARY

Embodiments of the present invention are directed to a computer-implemented method of deploying deep learning models at edge devices without retraining. According to an aspect, a computer-implemented method includes receiving, from a user an identification of a computing task to be performed by an edge device and obtaining, a data set corresponding to the computing task. The method also includes determining a supernet model space based at least in part on the computing task and creating a plurality of trained models for the computing task by training a plurality of deep learning models within the supernet model space with the data set. The method furthers include deploying one of the plurality of trained models to the edge device, wherein the one of the plurality of trained models is determined based at least in part on one or more characteristics of the edge device.

In one embodiment of the present invention, the one or more characteristics of the edge device are provided by the user.

In one embodiment of the present invention, the one or more characteristics of the edge device are determined by performing a test operation on the edge device.

In one embodiment of the present invention, the one or more characteristics of the edge device include one or more of an amount of available memory on the edge device, a processing power of the edge device, a network connection of the edge device, and an operating system executing on the edge device.

In one embodiment of the present invention, the method also includes monitoring the one or more characteristics of the edge device and based on a determination that the one or more characteristics has changed by more than a threshold amount, deploying another one of the plurality of trained models to the edge device.

In one embodiment of the present invention, the method also includes displaying, to the user, one or more operating requirements for each of the plurality of trained models, wherein the one of the plurality of trained models deployed to the edge device is determined based at least in part on a selection by the user.

In one embodiment of the present invention, the computing task is one of image classification, object detection, and image segmentation.

According to another non-limiting embodiment of the invention, a system having a memory having computer readable instructions and one or more processors for executing the computer readable instructions, the computer readable instructions controlling the one or more processors to perform operations. The operations include receiving, from a user an identification of a computing task to be performed by an edge device and obtaining, a data set corresponding to the computing task. The operations also include determining a supernet model space based at least in part on the computing task and creating a plurality of trained models for the computing task by training a plurality of deep learning models within the supernet model space with the data set. The operations further include deploying one of the plurality of trained models to the edge device, wherein the one of the plurality of trained models is determined based at least in part on one or more characteristics of the edge device.

According to another non-limiting embodiment of the invention, a computer program product for deploying deep learning models at edge devices without retraining is provided. The computer program product includes a computer-readable storage medium having program instructions embodied therewith, the program instructions executable by a processor to cause the processor to perform operations. The operations include receiving, from a user an identification of a computing task to be performed by an edge device and obtaining, a data set corresponding to the computing task. The operations also include determining a supernet model space based at least in part on the computing task and creating a plurality of trained models for the computing task by training a plurality of deep learning models within the supernet model space with the data set. The operations further include deploying one of the plurality of trained models to the edge device, wherein the one of the plurality of trained models is determined based at least in part on one or more characteristics of the edge device.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 is a block diagram of a system for deploying deep learning models at edge devices without retraining in accordance with one or more embodiments of the present invention;

FIG. 3 is a flowchart of a method for deploying deep learning models at edge devices without retraining in accordance with one or more embodiments of the present invention; and

FIG. 4 is a block diagram of a user interface for use in deploying deep learning models at edge devices without retraining in accordance with one or more embodiments of the present invention.

### DETAILED DESCRIPTION

As discussed above, edge computing devices typically have limited available memory and limited available processing power, which restricts the ability to train a deep learning model on an edge device. Disclosed herein are methods, systems and computer program products for creating a plurality of trained models based on a client data set and an identified computing task and deploying one of the plurality of trained models to an edge device based on the characteristics of the edge device. In exemplary embodiments, the edge device is not configured to perform any fine-tuning, training or adaptations of the deployed trained model. Rather, a separate processing system is configured to identify an appropriate model from one or more of the plurality of trained models based on a computational budget of an edge device.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as deploying models at edge device without retraining 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

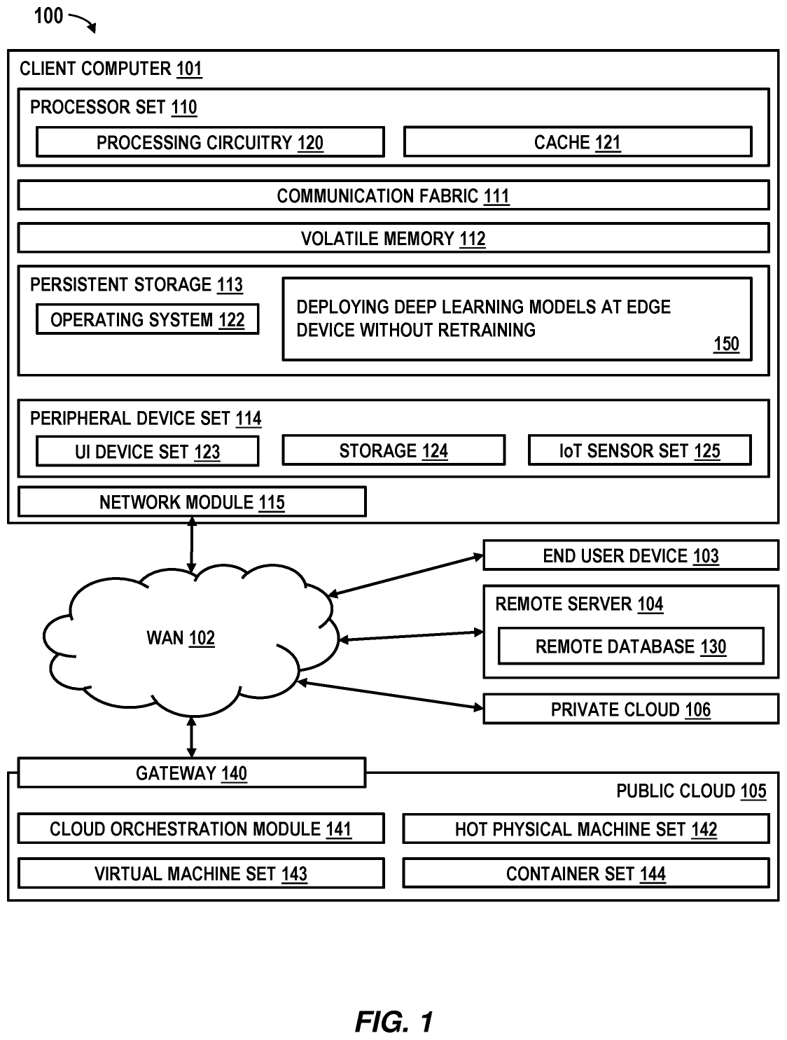

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

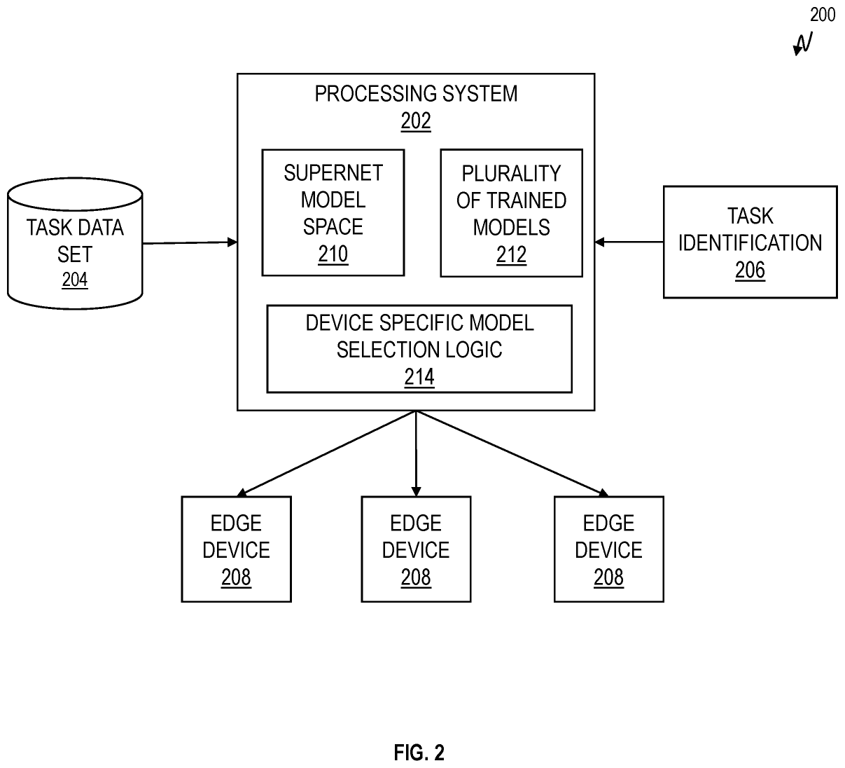

Referring now to FIG. 2, a system 200 for deploying deep learning models at edge devices in accordance with one or more embodiments of the present invention is shown. In exemplary embodiments, the system 200 includes a processing system 202 that may be embodied in a computer 101, such as the one shown in FIG. 1. As illustrated, the system 200 includes a processing system 202 that is configured to receive a task identification 206 and a task data set 204. In exemplary embodiments, the task identification 206 specifies a type of computing task that will be performed by an edge device 208. The computing tasks may include, but are not limited to, image classification, object detection, and image segmentation. The task data set 204 is a sample data set that includes one more data objects and classifications corresponding to each data object.

In exemplary embodiments, device specific model selection logic 214 of the processing system 202 is configured to select a supernet model space 210 based on the task identification 206. A supernet model is a deep learning model (such as convolutional neural network) where some of the architectural parameters (number of residual blocks per stage, number of neurons per layer, convolutional kernel size, etc.) of the model can be chosen dynamically from a predefined set and the model weights corresponding to the largest configuration (obtained by selecting the maximum allowed value for each of the architectural dimensions) defines the model weights for all other configurations (called sub-nets or equivalently called sub-models). In other words, a supernet is a large base model that is trained with a desired dataset and is configured in such a way that it can be manipulated by an algorithm to extract sub-nets/sub-models from it, where each sub-net is a fully functional model in itself by inheriting appropriate subset of model weights from the base model. In exemplary embodiments, selecting the supernet model space 210 includes specifying a model configuration that includes ranges for the number of layers, the number of blocks, the kernel size and the like for a convolutional neural network. The selected supernet model space 210 includes a plurality of deep learning models based on the model configuration. In exemplary embodiments, a size of each of the plurality of deep learning models is determined based on the number of layers, the number of blocks, the kernel size and the like for the convolutional neural network corresponding to deep learning models.

Once the supernet model space 210 has been selected, the processing system 202 is configured to train each of the plurality of deep learning models based on the task data set 204 to create a plurality of trained models 212. In exemplary embodiments, each of the plurality of trained models 212 are configured to have different sizes and to be optimized for execution in different computing environments that have different memory, processing, and/or latency constraints. In exemplary embodiments, one or more of the plurality of trained models 212 are deployed to each edge device 208 based at least in part on one or more characteristics of the edge device 208. The one or more characteristics of the edge devices 208 may include, but are not limited to, an amount of available memory on the edge device, a processing power of the edge device, a network connection of the edge device, and an operating system executing on the edge device.

In exemplary embodiments, the processing system 202 is configured to identify an appropriate model from one or more of the plurality of trained models 212 based on a computational budget of an edge device. The processing system 202 does not perform any model fine-tuning/GPU computation or evolutionary searches during the selection of the trained model deployed to the edge devices 208. In addition, the edge device 208 does not perform any fine-tuning, training or adaptations of the deployed trained model.

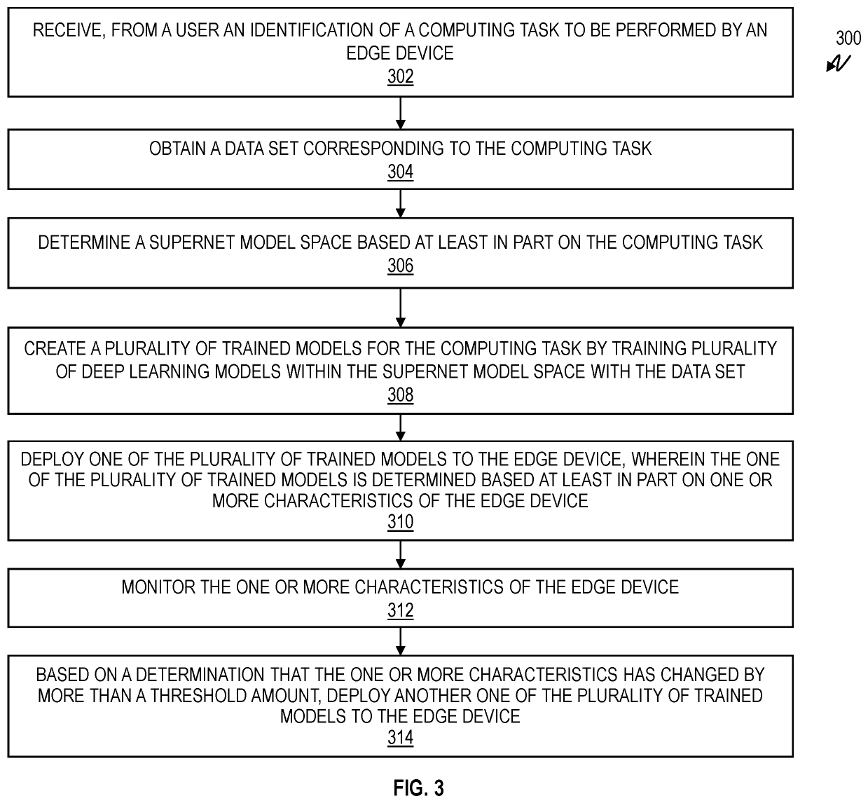

Referring now to FIG. 3, a flowchart of a method 300 for deploying models at edge devices without retraining in accordance with one or more embodiments of the present invention is shown. The method 300 beings at block 302 by receiving, from a user an identification of a computing task to be performed by an edge device. In exemplary embodiments, the computing task is one of image classification, object detection, and image segmentation. Next, as shown at block 304, the method 300 includes obtaining a data set corresponding to the computing task. In exemplary embodiments, the data set includes one more data objects and classifications corresponding to each data object.

The method 300 also includes determining a supernet model space based at least in part on the computing task, as shown at block 306. In one embodiment, a supernet model space includes a plurality of deep learning models that are selected based on a model configuration. The model configuration includes ranges for the number of layers, the number of blocks, the kernel size and the like for a convolutional neural network. Next, as shown at block 308, the method 300 includes creating a plurality of trained models for the computing task by training the plurality of deep learning models within the supernet model space with the data set. In exemplary embodiments, each of the plurality of trained models are configured to have different sizes and to be optimized for execution in different computing environments that have different memory, processing, and/or latency constraints.

Next, as shown at block 310, the method 300 includes deploying one of the plurality of trained models to the edge device, wherein the one of the plurality of trained models is determined based at least in part on one or more characteristics of the edge device. In exemplary embodiments, the one or more characteristics of the edge device include one or more of an amount of available memory on the edge device, a processing power of the edge device, a network connection of the edge device, and an operating system executing on the edge device. In one embodiment, the one or more characteristics of the edge device are provided by the user. In another embodiment, the one or more characteristics of the edge device are determined by performing a test operation on the edge device. In one embodiment, the method 300 includes displaying, to the user, one or more operating requirements for each of the plurality of trained models and the one of the plurality of trained models deployed to the edge device is determined based at least in part on a selection by the user.

The method 300 also includes monitoring the one or more characteristics of the edge device, as shown at block 312. Based on a determination that the one or more characteristics has changed by more than a threshold amount, the method 300 includes deploying another one of the plurality of trained models to the edge device, as shown at block 314. In one example, available memory on an edge device is monitored and the deployed trained model includes a minimum available memory amount. Based on a determination that the available memory on the edge device has fallen below the minimum available memory amount, an alternative trained model is identified and deployed to the edge device. The alternative trained model is identified based at least in part on the available memory on an edge device. In particular, the system dynamically extracts the desired model from the supernet without having to re-train/fine-tune any model. Note that other existing supernet-based approaches rely on a computationally costly searching mechanism (such as evolutionary search) for extracting an appropriate sub-model. Instead, the current approach generates a palette of appropriate sub-models for deployment into different types of edge devices at the end of the training procedure itself and during deployment the largest sub-model (in terms of number of parameters, flops or another suitable metric) that fits the edge device's latency or memory requirements is selected from that palette sub-models without any evolutionary search.

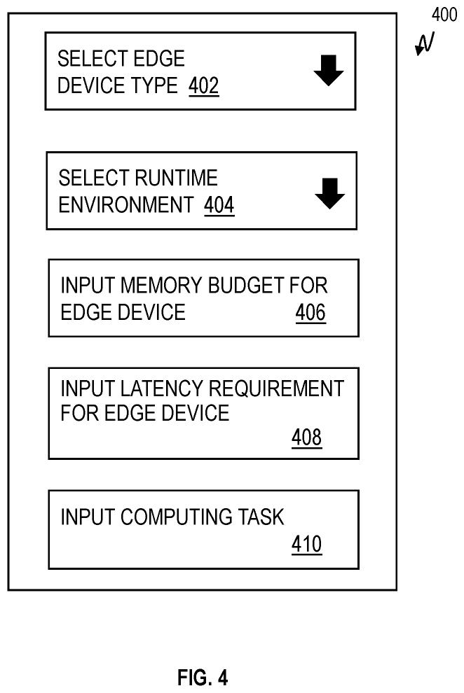

Referring now to FIG. 4, a user interface 400 for use in deploying deep learning models at edge devices without retraining in accordance with one or more embodiments of the present invention is shown. As illustrated, the user interface 400 includes an edge device type selection box 402 that is configured to allow a user to select a type of the edge device that the deep learning model will be deployed on. The type of the edge device may include a make and model of the edge device. The user interface 400 also includes a runtime selection box 404 that is configured to allow a user to select a runtime environment that is executing on the edge device that the deep learning model will be deployed on. The user interface 400 further includes a user input for a memory budget 406 for the edge device that the deep learning model will be deployed on. The user interface 400 also includes a user input for a latency requirement 408 for the edge device that the deep learning model will be deployed on. The user interface 400 also includes a user input for a computing task 410 that the edge device will perform.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, from a user an identification of a computing task to be performed by an edge device;
obtaining, a data set corresponding to the computing task;
determining a supernet model space based at least in part on the computing task;
creating a plurality of trained models for the computing task by training a plurality of deep learning models within the supernet model space with the data set; and
deploying one of the plurality of trained models to the edge device, wherein the one of the plurality of trained models is determined based at least in part on one or more characteristics of the edge device.

2. The computer-implemented method of claim 1, wherein the one or more characteristics of the edge device are provided by the user.

3. The computer-implemented method of claim 1, wherein the one or more characteristics of the edge device are determined by performing a test operation on the edge device.

4. The computer-implemented method of claim 1, wherein the one or more characteristics of the edge device include one or more of an amount of available memory on the edge device, a processing power of the edge device, a network connection of the edge device, and an operating system executing on the edge device.

5. The computer-implemented method of claim 1, further comprising:
monitoring the one or more characteristics of the edge device; and
based on a determination that the one or more characteristics has changed by more than a threshold amount, deploying another one of the plurality of trained models to the edge device.

6. The computer-implemented method of claim 1, further comprising:
displaying, to the user, one or more operating requirements for each of the plurality of trained models, wherein the one of the plurality of trained models deployed to the edge device is determined based at least in part on a selection by the user.

7. The computer-implemented method of claim 1, wherein the computing task is one of image classification, object detection, and image segmentation.

8. A system comprising:
a memory having computer readable instructions; and
one or more processors for executing the computer readable instructions, the computer readable instructions controlling the one or more processors to perform operations comprising:
receiving, from a user an identification of a computing task to be performed by an edge device;
obtaining, a data set corresponding to the computing task;
determining a supernet model space based at least in part on the computing task;
creating a plurality of trained models for the computing task by training a plurality of deep learning models within the supernet model space with the data set; and
deploying one of the plurality of trained models to the edge device, wherein the one of the plurality of trained models is determined based at least in part on one or more characteristics of the edge device.

9. The system of claim 8, wherein the one or more characteristics of the edge device are provided by the user.

10. The system of claim 8, wherein the one or more characteristics of the edge device are determined by performing a test operation on the edge device.

11. The system of claim 8, wherein the one or more characteristics of the edge device include one or more of an amount of available memory on the edge device, a processing power of the edge device, a network connection of the edge device, and an operating system executing on the edge device.

12. The system of claim 8, wherein the operations further comprise:
monitoring the one or more characteristics of the edge device; and
based on a determination that the one or more characteristics has changed by more than a threshold amount, deploying another one of the plurality of trained models to the edge device.

13. The system of claim 8, wherein the operations further comprise:
displaying, to the user, one or more operating requirements for each of the plurality of trained models, wherein the one of the plurality of trained models deployed to the edge device is determined based at least in part on a selection by the user.

14. The system of claim 1, wherein the computing task is one of image classification, object detection, and image segmentation.

15. A computer program product comprising a computer readable storage medium having program instructions embodied therewith, the program instructions executable by a processor to cause the processor to perform operations comprising:
receiving, from a user an identification of a computing task to be performed by an edge device;
obtaining, a data set corresponding to the computing task;
determining a supernet model space based at least in part on the computing task;
creating a plurality of trained models for the computing task by training a plurality of deep learning models within the supernet model space with the data set; and
deploying one of the plurality of trained models to the edge device, wherein the one of the plurality of trained models is determined based at least in part on one or more characteristics of the edge device.

16. The computer program product of claim 15, wherein the one or more characteristics of the edge device are provided by the user.

17. The computer program product of claim 15, wherein the one or more characteristics of the edge device are determined by performing a test operation on the edge device.

18. The computer program product of claim 15, wherein the one or more characteristics of the edge device include one or more of an amount of available memory on the edge device, a processing power of the edge device, a network connection of the edge device, and an operating system executing on the edge device.

19. The computer program product of claim 15, wherein the operations further comprise:
monitoring the one or more characteristics of the edge device; and
based on a determination that the one or more characteristics has changed by more than a threshold amount, deploying another one of the plurality of trained models to the edge device.

20. The computer program product of claim 15, wherein the operations further comprise:
displaying, to the user, one or more operating requirements for each of the plurality of trained models, wherein the one of the plurality of trained models deployed to the edge device is determined based at least in part on a selection by the user.
